(19) United States
(12) Patent Application Publication
(10) Pub. No.: US 2015/0296341 A1
(43) Pub. Date: Oct. 15, 2015

(54) SYSTEMS AND METHODS FOR FINDING MOBILE DEVICE USERS

(71) Applicant: LIBERA, INC., Jamestown, NY (US)

(72) Inventors: Albert B. Cecchini, (US); Moussa Doumbouya, Revere, MA (US)

(21) Appl. No.: 14/433,088

(22) PCT Filed: Oct. 3, 2013
(86) PCT No.: PCT/US13/63260

§ 371 Date: Apr. 2, 2015

Related U.S. Application Data
(63) Continuation-in-part of application No. 13/644,807, filed on Oct. 4, 2012.

(51) Int. Cl. H04W 4/02; H04L 29/08; G01S 19/01

(52) U.S. Cl. CPC H04W 4/023; G01S 19/01; H04L 67/18

(57) ABSTRACT

A system and method is provided for enabling mobile device users to share their respective locations and provide maps to each other's locations without requiring the use of a central server providing location services. The other user's location is provided as GPS coordinates that are attached to the communications between the parties (e.g., SMS, text, voice, etc.) and used to generate the other user's location on a map generated at the recipient's mobile device. In operation, a simple communication is provided to another user requesting his/her location and the GPS coordinates of the recipient are returned directly to the requester's mobile device for providing through an API to map or navigation or game software or hardware. The generated map is provided to the requester's mobile device, thereby bypassing the central server.

### CROSS-REFERENCE TO RELATED APPLICATIONS

The present patent application is a continuation-in-part application of U.S. patent application Ser. No. 13/644,807, filed Oct. 4, 2012. The contents of that application are hereby incorporated by reference.

### TECHNICAL FIELD

This patent application pertains to systems and methods for finding a mobile device user's GPS location. More specifically, it describes a method of and apparatus for enabling a first mobile device user to locate another mobile device user by asking for their GPS location using a central server only to transmit the communications between the two devices and not to manage the navigation process. Once the GPS location is received at the requester's mobile device, the GPS location data is used for various applications including those that provide navigation to the received GPS location. In addition, this patent application describes a method in which a mobile device user sends his/her GPS location unsolicited to a second mobile device user using a central server only to transmit the communications between the two devices and not to manage the navigation process.

### BACKGROUND

Systems and methods are known for enabling a first mobile phone user to enable other mobile phone users, typically friends and family, to plot the first mobile phone user's location on a map using GPS coordinates provided by the first user's mobile phone. For example, the Latitude service offered by Google provides an application on the first user's mobile phone that enable's the first user's mobile phone to provide the first user's GPS location on Google maps to designated recipients. For example, the first user's mobile phone provides the first user's GPS location to friends and family by providing the first user's icon or picture on a Google map to friends and/or family and to hide his/her location from unauthorized recipients. The Latitude service also enables mobile phone users to “check-in” at a location on a Google map so that their friends and family will know that the mobile phone user has arrived at a designated location. Also, by checking the Google map with the locations of friends identified, the users may identify who is nearby and meet up.

Apple offers a similar service called Find My Friends. To use the Find My Friends service, a first mobile phone user downloads an application to his/her mobile phone that allows the first mobile phone user to share his/her location with designated friends and family. The first mobile phone user's location will appear on a map provided through Apple's Contact and Maps mobile phone features. Other applications that may be downloaded to the mobile phone enable the designated friends and family to find the quickest route to the first mobile phone user's location. Thus, using this Find My Friends service, mobile phone users may find their way to events, keep track of friends and family in crowded areas, and otherwise allow users to keep track of the locations of their friends and family. As with Google's Latitude service, privacy settings permit the users to limit who may gain access to the location information.

The Google and Apple services require the use of a central server in a system of the type generally shown in FIG. 1. As illustrated in FIG. 1, the Requester (User #1) sends a request for the location of a Listener (User #2). However, this location request is provided to a central server 100 that waits for a response from User #2 indicating whether or not User #2's location may be provided to User #1. To obtain such approval, the central server 100 issues a request for location (102) to User #2 indicating that User #1 would like User #2's location. If User #2 agrees to provide his/her location to User #1, the location request is received at 104 and a “go get location” function 106 calls GPS function 108 and sends the GPS location of User #2 at 110 back to the central server 100. If the location of User #2 has been so provided and User #1 is allowed access, the mapping server of the central server 100 launches a map at 112 that is provided to User #1's mobile phone showing User #2's icon or picture on the map on the display of User #1's mobile phone. A Navigator application 114 may also be provided on User #1's mobile phone so that User #1 may navigate through the map. The central server 100 tracks the location of User #2 by periodically sending location requests to which User #2's mobile phone provides GPS location data in response. User #2's location is then updated my moving User #2's icon or picture on the map provided to User #1.

U.S. Pat. Nos. 7,756,527 and 7,756,529 disclose a similar system that uses a central server in a position information management system. The holder of a portable remote terminal receives a map of the local area and can receive a map update from the central system when the user navigates outside of the current map area. The positions of third parties can be provided on the displayed map and the positions updated at a prescribed interval.

Other known systems provide wireless technologies for navigating a person from a starting point to a destination using a wireless navigating device. For example, U.S. Pat. No. 7,499,797 describes a system that periodically sends the current geographic location of a person as he/she travels to a central database server and periodically receives additional navigational information from the central database server in response to the periodically sent information to update the person regarding his/her navigational path. This system also permits the users to move around and to name locations in their environment.

Thus, in conventional prior art location systems using mobile phones, a central server provides the functionality for the location services. Unfortunately, the constant location polling of the users' mobile phones by the central server causes significant battery drain of the users' mobile phones. Also, since the users interact through a central server, the users are unable to directly communication their GPS data to each other and must instead rely upon the data presentation of the central server. A system and associated method are desired that enables these and other useful location services to be provided without requiring a central server to provide the functionality for the location services and without requiring the battery drain caused by the constant location polling of the central server. The present invention addresses these needs in the art.

### SUMMARY

Systems and methods are provided whereby mobile device (e.g., mobile phone, smart phone, tablet, laptop, etc.) users may share the GPS coordinates of their respective locations without requiring the use of a central server to provide the functionality for the location services. By allowing the users to control the frequency of the location polling, without a central server polling at a frequency out of control of the user, battery drainage is limited, or at least controlled, by the respective users. Once the requester has been approved and has received the GPS location of the polled mobile device user, any mobile device based application may be called at the discretion of the user. In an exemplary embodiment, once the GPS location of the other party is received, map software and navigation software provided as applications on the mobile device are launched and accessed via an API to plot or navigate to the location of the other person's GPS coordinates. In an exemplary embodiment, two or more mobile devices may be paired so that access to GPS coordinates is pre-approved and permission is not required to provide the respective GPS coordinates. Other applications, such as game applications, that use location coordinates may also be launched and accessed via an API. In these embodiments, server use is not required for the location services but is adjunct to the process of requesting and receiving locations. Communications bypass the central server and are provided directly between the sender and receiver using SMS, text, voice, or some other data transmission protocol known in the art. Thus, by providing GPS data directly to another user or by sending a simple communication to another user requesting his/her location, the received GPS coordinates may be used by any mobile device application of the recipient's mobile device, such as navigation and map generation software or game software, to locate the other user on a map or in game play.

Also, by sending a simple communication to one's own mobile device including the current GPS coordinates of the mobile device and providing a means for the user to label it, the user may generate a “flag” marking a spot to which the user wishes to navigate back to at a later time. As the recipient of their own location request, the sender now has all of the functionality that a recipient possesses for navigation, mapping, and the like. By adding the ability to save the sender's own current location to themselves and labeling it, the sender now has a mechanism for mapping and navigating back to locations of importance at some future time.

The techniques described herein may also be used to track objects having location tracking features.

These and other embodiments of the invention will be apparent to those skilled in the art from the following detailed description.

### BRIEF DESCRIPTION OF THE DRAWINGS

FIG. 1 shows a conventional system for allowing users to share their locations with each other using mobile phones and a central server that controls the location services functionality.

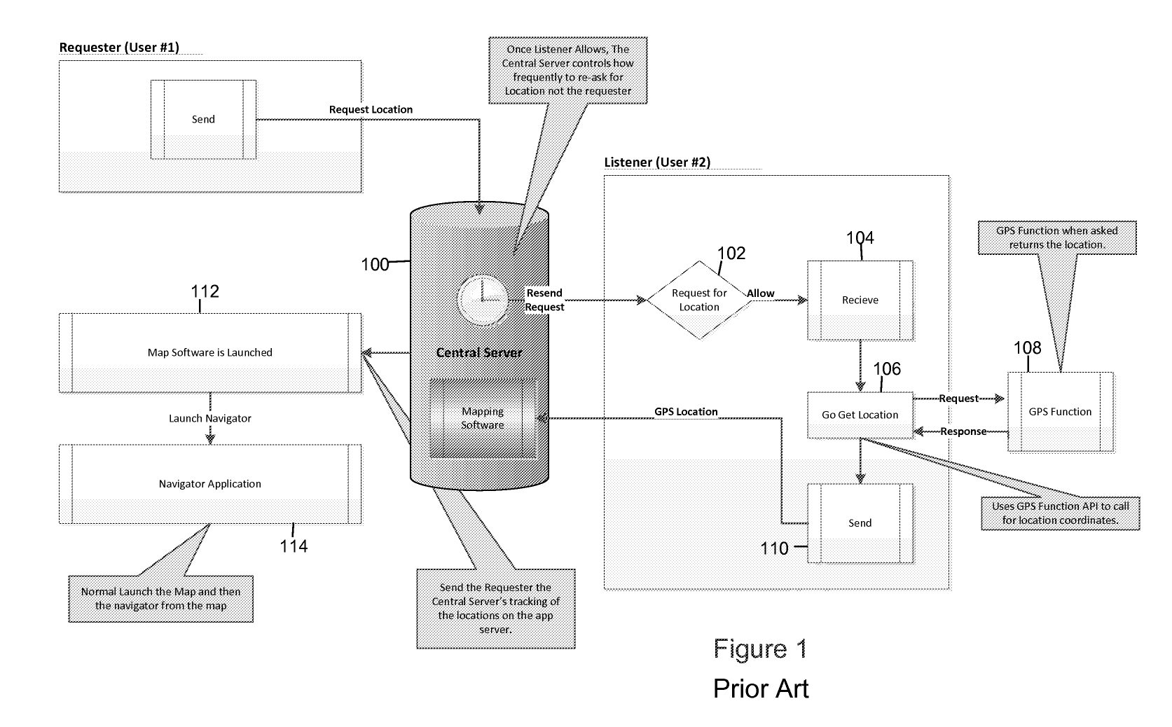

FIG. 2 shows an exemplary system that allows users to share their locations with the provision of maps and navigation as adjunct processes to the direct communications of location coordinates between the two parties.

FIG. 3 illustrates an exemplary mobile phone having GPS capability and a processor that may be programmed to implement the method of the invention.

### DETAILED DESCRIPTION OF ILLUSTRATIVE EMBODIMENTS

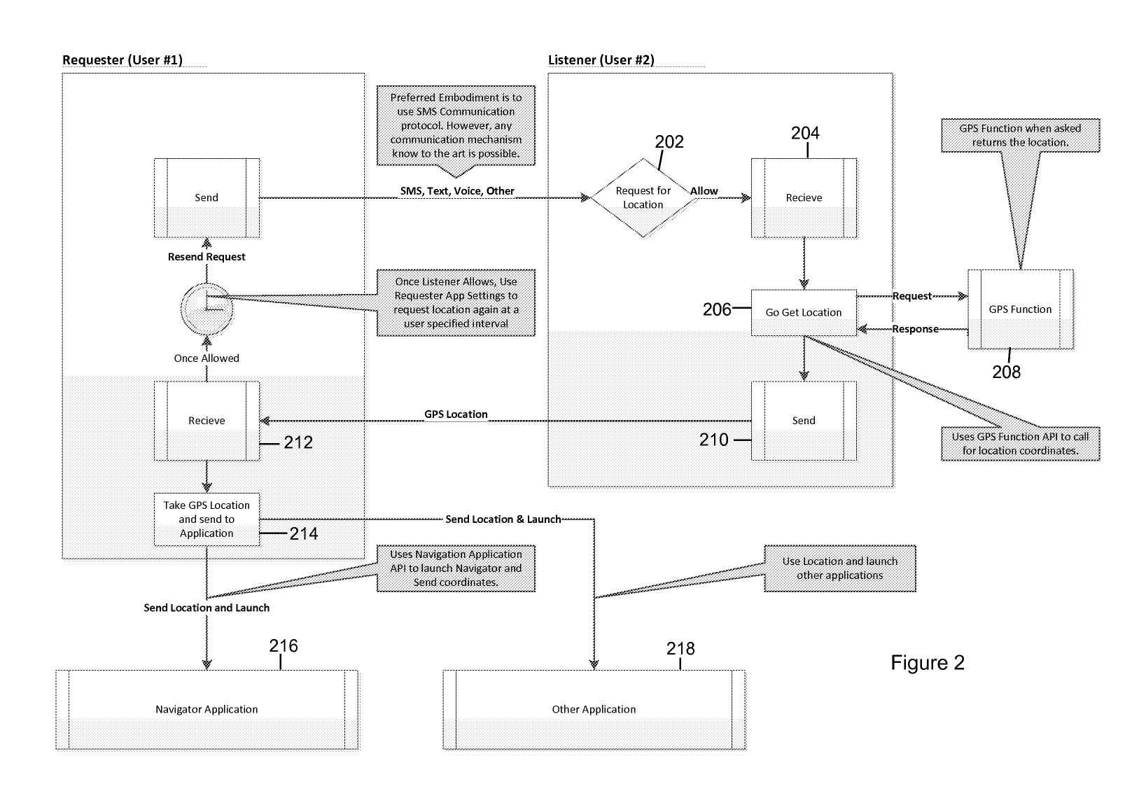

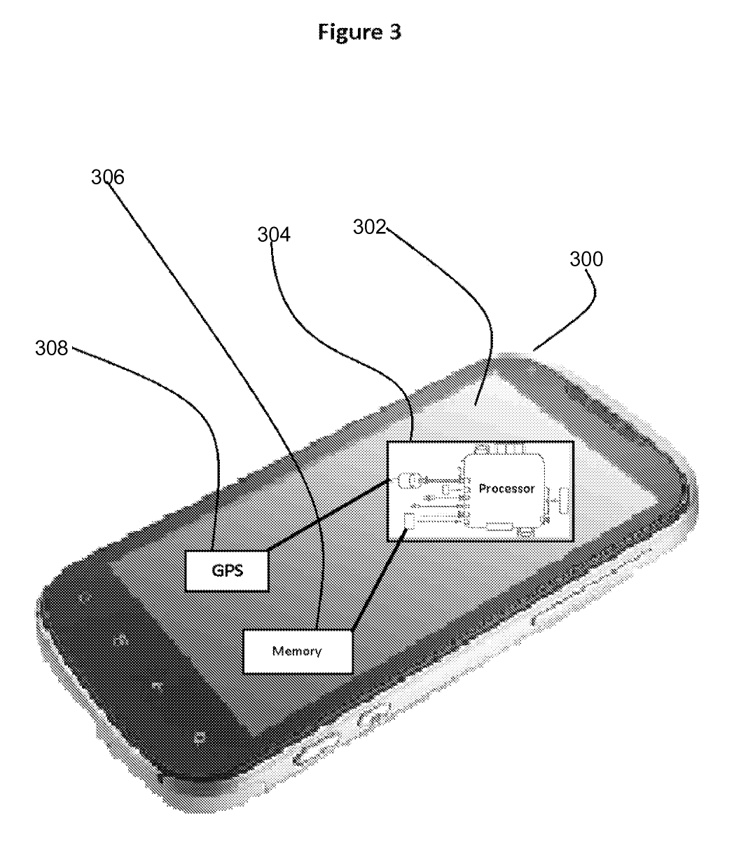

An exemplary embodiment of the invention will be described with reference to FIGS. 2 and 3 for use with conventional mobile devices (e.g., phones of the type illustrated in FIG. 3) having GPS location system software. Those skilled in the art will appreciate that the teachings provided herein may be used with other mobile devices, such as a smart phone, tablet, or a laptop, equipped with GPS location software.

FIG. 2 illustrates a sample embodiment of the invention whereby users may share their locations and in an adjunct way call maps and navigation processes for directions to the other person's location. As illustrated, the Requester (User #1) sends a location request to a Listener (User #2) using convention mobile phone communications methods such SMS, text, voice, SSP (tones), e-mail, and the like. Upon receipt of the location request at 202, User #2 decides whether to provide his/her location to User #1 and, if approval is provided, the location request is received at 204 and a “go get location” function 206 calls GPS function 208 and sends the GPS location of User #2 back to User #1 as GPS location data at 210. The GPS location data may be sent using the same or different communication method. Conversely, User #2 may simply send his/her GPS location data to User #1 unsolicited so that User #1 can use the provided GPS coordinates to navigate to User #2, generate a map to User #2, include User #2's location in a game on User #1's device, and the like. User #1 (the requester) can also request positional information from themselves to be used to label and save their current location information without the use of a centralized server. As such, User #1 in effect also becomes the Listener (i.e. User #2) with all of the associated functionality. With this functionality, User #1 can map, navigate, and the like back to any prior saved location of their choosing.

After sending the location request, User #1's mobile device waits for the GPS location data. If the GPS location data has not been received at a user specified interval, a new location request may be sent using the same or a different communication method. Then, once the GPS location data is received by User #1's mobile device at 212, the GPS location data is extracted at 214 from the message and sent to an application that uses an API to a navigation application 216 such as Google's Navigation software. Navigator is launched and provided with the GPS coordinates and used to generate a map that is provided locally to User #1's mobile device. The GPS location data may also be used to launch other applications 218 as desired. For example, the location data of User #1 and User #2 may be provided via an API to an application such as MapQuest or a self-contained GPS device such as a Garmin for generation of a map and/or directions from User #1's GPS position to User #2's GPS position. Additionally, the location data of User #1 and/or User #2 may be provided via an API to game software including the locations of users in the game play. For example, the GPS data may be used in a Marco Polo game or in a game of “warmer/colder.” The GPS data may also be provided to a cache for GPS caching and the like.

In the exemplary embodiment, the request for the User #2's position may be generated manually or automatically. For example, the request for User #2's position may be sent manually as when User #1 generates a location request message or makes a phone call to User #2. On the other hand, User #1's mobile device may be programmed to send a location request message at a polling interval selected by User #1. Preferably, the polling interval is selected by User #1 to take into account the amount of power remaining on User #1's battery (less power =less frequent polling). Then, once User #2's updated location data is received, the updated location data may again be sent to adjunct location software such as Google Maps, Apple Maps, or MapQuest or to a self-contained device such as a Garmin to provide directions or visual or audio navigation from User #1's current location to User #2's new location.

Those skilled in the art will appreciate that the methods described herein are provided using software downloaded into the processors of the users' mobile devices or firmware contained within the device. An exemplary mobile phone 300 is illustrated in FIG. 3. As illustrated, the mobile phone 300 includes a display 302, a processor 304, a memory 306 that, for example, stores instructions for execution by processor 304 to implement the processes of the invention as described herein, and a GPS device 308. The software is preferably loaded into memory 306 and includes software flow for sending requests for location data, denying or accepting those requests, if accepted sending the location data and then launching adjunct applications and/or processes. In the case of sending and displaying location data, the software flow includes sending a request for location data and waiting for a response for a manually or automatically specified time interval. If the location data has not been received before the specified time interval expires, the request for location data may be resent using the same or another specified transmission modality or the process may end. This process repeats until location data is received or the process ends. On the other hand, the GPS location data may be received unsolicited from another device. Upon receipt of location data, the GPS location data is provided to an API that accesses navigation software such as Navigation available from Google. The GPS coordinate data is provided to Navigator for generation of a map. The software then waits for the map and presents the map on User #1's mobile device's display screen upon receipt. The map includes an icon, photo or other image indicating the location of User #2 on the map. Also, either automatically or upon user selection, the GPS coordinates of User #1 and User #2 may be provided through an API to a self-contained navigation device such as a Garmin or to a software navigation application such as MapQuest for generating directions from User #1's most recent location to User #2's most recent location. The software then waits for the directions and presents the directions on User #1's mobile device's display screen upon receipt. This process is repeated automatically at user specified intervals or manually when User #1 manually designates that he/she would like updated location information for User #2.

In another embodiment of the method of the invention, a pairing function may be added whereby the request receiver allows or can just submit to another party which pre-approves sending the GPS location when requested. For example, a parent may want to always be able to find a child. They send a request to the child. The child says “yes” and the parent forces them to pair with the parent's “come find me” application implemented on the parent's phone using the system described herein. Then, the parent can send a request in the future and the child's application will send the GPS location without requesting permission. Pairing with at least one other phone will also allow the phone to easily be found if stolen.

In an exemplary embodiment, the pairing would be performed in one of the following ways:

1. Phone 1 asking Phone 2 for its location:

Phone 1 sends a request. Phone 2 sees the request and has the option of pairing with Phone 1's application. If they select to pair, then there is a password dialog that appears for Phone 2 to type a password. Once the password is typed, Phone 2 presses (or gives the voice command) to execute the pairing. Phone 2's application then sends the password to the sender's phone through text, voice, tones, etc. and the password is saved in both phones. Then, when Phone 1 makes a future request for Phone 2's location, the application checks to see if the systems are paired by confirming that the stored password matches. If a match is found, then the location is automatically sent. The sending of the location can be silent or may give Phone 2 a notification about the sending. If the pairing is not accepted, then just the GPS location is processed and no password is stored.

2. Phone 2 unsolicited sends Phone 1 its location:

Phone 2 sends a request to have Phone 1 come to it. Phone 2's request has the option of also asking Phone l's application to pair with it. When Phone 1 receives the location and the request to pair, a dialog appears for Phone 1 to accept the pairing or just the location. Once accepted through typing or a voice command, the password is saved in both phones. Then, when Phone 1 makes a future request for Phone 2's location, the application checks to see if the systems are paired by confirming that the stored password matches. If a match is found, then the location is automatically sent. The sending of the location can be silent or give Phone 2 a notification about the sending. If the pairing is not accepted, then just the GPS location is processed and no password is stored.

On the other hand, the software for responding to requests for location data includes a privacy check feature for checking whether the sender of a received message is a trusted friend or family member to which the user agrees to provide his/her location. If not, the software may generate a suitable message back to the requester indicating that the recipient is unwilling to divulge his/her location. Conversely, no message could be generated and the process would simply end. If the message is from a trusted friend or family member and is approved, or if the user desires to send unsolicited GPS position data to another user, then the mobile device's GPS API is called to get GPS data indicating the location of the user's mobile device. The software waits for this GPS position data and, upon receipt, generates a message back to the requester's (or designated recipient's) mobile device using the requester's ID provided in the originally received message or stored in the user's mobile device. For example, the GPS location data may be modulated onto SSP tones or attached to an SMS text message and sent back to the requester's (recipient's) mobile device. Once the GPS location data has been sent, the software waits for the next location request.

Those skilled in the art will appreciate that the method of the invention may be used to provide the locations of multiple users on a map by sending location request messages to multiple users in a designated group and in an adjunct way mapping the received GPS coordinates of the respective group members on a map on the requester's mobile device. The locations could be updated at intervals designated by the requester.

Those skilled in the art will further appreciate that the method of the invention may be used by one to send himself/herself a message that contains the GPS locations where he/she has to set an “anchor” or “Flag” in the ground so that he/she can find that spot in the future by opening the flag from a list of labeled flags and selecting it. In this way, one may navigate back to that spot using the GPS software on the user's mobile device. For example, a user may plant the flag at his/her car in the parking lot or a frequented store, etc. by sending the current GPS location to himself/herself and then use the GPS software to navigate back to the car. The “flag” will also help blind people and early Alzheimer's patients to maintain their independence by providing a new way to navigate.

Those skilled in the art will further appreciate that while the disclosure contained herein pertains to providing location data between mobile device users and providing maps and directions for locating such mobile device users, it should be understood by those skilled in the art that this is only one of many possible applications. Other embodiments within the scope of the invention include, for example, communicating and displaying GPS position data for fixed locations, fixed or movable objects, vehicle, airplane, or pet tracking systems, and any other application in software or hardware that utilizes or can utilize GPS information, such as games or other applications, self-contained hardware navigation systems know in the art such as Garmin, and the like. The communication of the GPS position data may be visual or auditory. Those skilled in the art will further appreciate that central servers may be utilized in the communication path between the mobile devices (e.g., SMS, text, voice, SSP (tones), e-mail, and the like) but that such central servers do not perform the location services that are performed without the use of a central server in accordance with the techniques of the invention. All such embodiments are intended to be included within the scope of the invention as defined by the attached claims.

What is claimed:

1. A method of tracking locations of mobile devices or objects having location tracking features, comprising the steps of:
a first mobile device receiving a message from a second mobile device or object over a communication channel between the first mobile device and the second mobile device or object, said communication channel not including a central server providing location services, and said message including GPS position data of the second mobile device or object; and
the first mobile device providing the GPS position data of the second mobile device or object to an API that accesses software or hardware.

2. The method of claim 1, further comprising the first mobile device providing the GPS position data of the second mobile device or object and GPS position data of the first mobile device to said API and said API providing said GPS position data to map generation software or hardware for generation of directions from the first mobile device to the second mobile device or object and, upon receipt of the generated directions, presenting the generated directions on a display of the first mobile device's display screen.

3. The method of claim 1, further comprising the steps of:
the first mobile device receiving a map from map or navigation software or hardware via said API, said map including an indication of the location of the second mobile device or object thereon; and
the first mobile device presenting the map with the indication of the location of the second mobile device or object thereon on a display of the first mobile device's display screen.

4. The method of claim 1, further comprising the steps of:
the first mobile device receiving instructions from game software via said API, said instructions from the game software including an indication of the location of the second mobile device or object; and
the first mobile device presenting the indication of the location of the second mobile device or object thereon on a display of the first mobile device's display screen or aurally as part of play of said game on said first mobile device.

5. The method of claim 1, further comprising automatically repeating the steps of claim 1 at user specified intervals.

6. The method of claim 1, further comprising repeating the steps of claim 1 upon manual request of a user of the first mobile device.

7. The method of claim 1, wherein the first mobile device provides the GPS position data to an independent hardware navigation device through the API.

8. The method of claim 1, wherein the message receiving step includes receiving the message from the second mobile device or object over the communication channel via SMS, text, voice, SSP tones, or email.

9. The method of claim 1, further comprising repeating the receiving step of claim 1 for multiple mobile devices and providing the GPS position data for each of the multiple mobile devices to the API.

10. The method of claim 9, further comprising the first mobile device providing the GPS position data of the second mobile device or object and GPS position data of the first mobile device to said API and said API providing said GPS position data to map generation software or hardware for generation of directions from the first mobile device to the second mobile device and, upon receipt of the generated directions, presenting the generated directions on a display of the first mobile device's display screen.

11. The method of claim 1, wherein said object comprises a vehicle, airplane, or pet having a tracking system.

12. The method of claim 1, further comprising the first mobile device sending a request for location data from a second mobile device or object via a second communication channel between the first mobile device and the second mobile device or object, and the message from the second mobile device indicating that the second mobile device or object has approved the request to provide GPS position data of the second mobile device to the first mobile device.

13. The method of claim 12, wherein the sending step includes the first mobile device transmitting the request for location data from the second mobile device or object over the second communication channel via SMS, text, voice, SSP tones, or e-mail.

14. The method of claim 1, further comprising pairing the first mobile device and the second mobile device whereby requests to provide GPS position data between the first mobile device and the second mobile device are pre-approved.

15. The method of claim 1, wherein the first mobile device sends a message to itself containing its current GPS position thereby providing itself with GPS position data for storing, labeling, and later retrieval and use by the first mobile device.

16. A mobile device comprising:
a memory storing an API to software or hardware and storing instructions for modifying the operation of a processor;
a display; and
a processor that executes said instructions to cause said processor to perform a method of tracking locations of other mobile devices or objects, said method including the steps of:
receiving a message from a second mobile device or object over a communication channel between the mobile device and the second mobile device or object, said communication channel not including a central server providing location services, and said message including GPS position data of the second mobile device or object, and
providing the GPS position data of the second mobile device or object to said API.

17. The mobile device of claim 16, wherein said memory further includes instructions that when executed by said processor cause said processor to perform the steps of providing the GPS position data of the second mobile device or object and GPS position data of the mobile device to said API for said API to provide said GPS position data to map generation software or hardware for generation of directions from the mobile device to the second mobile device or object and, upon receipt of the generated directions, presenting the generated directions on the display.

18. The mobile device of claim 16, wherein said memory further includes instructions that when executed by said processor cause said processor to perform the steps of:
receiving a map from map or navigation software or hardware via said API, said map including an indication of the location of the second mobile device or object thereon, and
presenting the map with the indication of the location of the second mobile device or object thereon on said display.

19. The mobile device of claim 16, wherein said memory further includes instructions that when executed by said processor cause said processor to perform the steps of:
receiving instructions from game software via said API, said instructions from the game software including an indication of the location of the second mobile device or object; and
presenting the indication of the location of the second mobile device or object thereon on said display or aurally as part of play of said game on said mobile device.

20. The mobile device of claim 16, wherein said processor automatically requests mobile device locations of other mobile devices or objects at user specified intervals.

21. The mobile device of claim 16, wherein said processor requests mobile device locations of other mobile devices or objects upon manual request of a user of the mobile device.

22. The mobile device of claim 16, wherein the mobile device provides the GPS position data to an independent hardware navigation device through the API.

23. The mobile device of claim 16, wherein the processor receives the message from the second mobile device or object over the communication channel via SMS, text, voice, SSP tones, or email.

24. The mobile device of claim 16, wherein the processor repeats the receiving step for multiple mobile devices and provides the GPS position data for each of the multiple mobile devices to the API for generation of a map including indications of the locations of each of the multiple mobile devices, said processor further presenting the map with the indication of the locations of each of the mobile devices thereon on the display.

25. The mobile device of claim 16, wherein the processor provides the GPS position data of the second mobile device or object and GPS position data of the mobile device to said API for generation of directions from the mobile device to the second mobile device or object by said map or navigation software or hardware and, upon receipt of the generated directions, presents the generated directions on the display.

26. The mobile device of claim 16, wherein said object comprises a vehicle. airplane, or pet having a tracking system.

27. The mobile device of claim 16, wherein said memory further includes instructions that when executed by said processor cause said processor to send a request for location data from the second mobile device or object via a second communication channel between the mobile device and the second mobile device or object, the message from the second mobile device indicating that the second mobile device or object has approved the request to provide GPS position data of the second mobile device to the mobile device.

28. The mobile device of claim 27, wherein the mobile device transmits the request for location data from the second mobile device or object over the second communication channel via SMS, text, voice, SSP tones, or e-mail.

29. The mobile device of claim 16, wherein the mobile device is paired with the second mobile device whereby requests to provide GPS position data between the mobile device and the second mobile device are pre-approved.

30. The mobile device of claim 16, wherein the mobile device sends a message to itself including its current GPS position data for storing, labeling, and later retrieval and use by the mobile device.
